(19) United States
(12) Patent Application Publication
(10) Pub. No.: US 2026/0003623 A1
(43) Pub. Date: Jan. 1, 2026

(54) Instruction Deltas For Processing-In-Memory Divergence

(71) Applicant: Advanced Micro Devices, Inc., Santa Clara, CA (US)

(72) Inventors: Shaizeen Dilawarhusen Aga, Santa Clara, CA (US); Mohamed Assem Abd ElMohsen Ibrahim, Santa Clara, CA (US)

(73) Assignee: Advanced Micro Devices, Inc., Santa Clara, CA (US)

(21) Appl. No.: 18/757,922

(22) Filed: Jun. 28, 2024

(51) Int. Cl. G06F 9/30

(52) U.S. Cl. CPC G06F 9/3016

(57) ABSTRACT

Instruction deltas for processing-in-memory divergence are described. In one or more implementations, a system includes a memory and a processing-in-memory component configured to identify an instruction delta based on one or more undefined portions of an instruction of a PIM command and decode the instruction delta into one or more defined portions of the instruction to be used in place of the undefined portions to execute the instruction. In one or more implementations, a processing-in-memory component includes at least one computational unit of an in-memory processor that identifies an instruction delta based on one or more undefined portions of an instruction of a PIM command, decodes the instruction delta into one or more defined portions of the instruction to be used during execution in place of the undefined portions, and executes the instruction based on the defined portions.

### BACKGROUND

Processing-in-memory (PIM) is the integration of computational units, such as processors, accelerators, or custom logic, directly within a memory system. PIM architectures leverage the parallelism and proximity of data processing within the memory system, reducing data movement and improving overall system performance. The computational units perform operations on the data stored within memory cells without requiring data movement to separate host processing units, such as a central processing unit (CPU) or a graphics processing unit (GPU). When a PIM-enabled memory bank receives a memory request, the computational units within the memory chips access and process the data directly from the memory cells. This reduces latency and energy consumption associated with data transfers to the host processing units.

### BRIEF DESCRIPTION OF THE DRAWINGS

FIG. 1 is a block diagram of a non-limiting example system having a host with at least one core, memory hardware that includes a memory and a processing-in-memory component that uses instruction deltas to manage divergence.

FIG. 2 is a block diagram of a non-limiting example memory architecture for a memory.

FIG. 3 depicts a non-limiting example PIM component for a memory, which is operable to process instruction deltas to manage divergence.

FIG. 4-1 depicts a code snippet as a non-limiting example of a PIM command defining PIM operations, including one or more instructions, executed through processing-in-memory.

FIG. 4-2 is an example implementation of a PIM command buffer without supporting instruction deltas to execute PIM operations defined by the code snippet depicted in FIG. 4-1.

FIG. 4-3 is a non-limiting example implementation of a PIM command buffer for supporting instruction deltas to execute PIM operations defined by the code snippet depicted in FIG. 4-1.

FIG. 5 depicts a non-limiting example implementation of a delta decode unit for decoding instruction deltas used to execute PIM operations extracted from PIM commands.

FIG. 6 depicts a non-limiting example implementation of a register coalescer unit for managing access of a register file used to execute PIM operations extracted from PIM commands that utilize instruction deltas.

FIG. 7 depicts a method performed by a system operable to process PIM commands utilizing instruction deltas.

FIG. 8 depicts a method performed by a processing unit to cause a system to process PIM commands utilizing instruction deltas.

FIG. 9 is a block diagram of a processing system configured to execute one or more applications, in accordance with one or more implementations.

### DETAILED DESCRIPTION

### Overview

Application workloads often involve both compute intensive and data intensive tasks. Processing and energy inefficiencies occur when a host processing unit, such as a CPU or a GPU, is used to perform each of the compute intensive tasks as well as each of the data intensive tasks. Computational units of a PIM architecture have more memory bandwidth for performing data intensive tasks than a host processing unit that is separated from the data. Bifurcating an application workload by offloading the data intensive tasks to a PIM architecture reduces data movement, processing latency, and energy consumption. Offloading data intensive tasks to a PIM architecture is not without challenges.

PIM architectures exploit potential for parallel processing based on data locality of memory systems. Each memory bank independently performs computations on its portion of the data, allowing for concurrent processing across multiple memory banks and exploiting data locality for faster access.

A memory controller and PIM component (also referred to throughout as an in-memory processor) work together to enable efficient and high-performance memory systems. The memory controller manages memory requests and data transfers between the host processing units. The PIM component leverages the computational units of the one or more in-memory processors within the memory system to process data directly within the memory, reducing data movement and enhancing system performance. In response to receiving memory requests via a memory interface shared with the host processing units, the memory controller issues PIM commands to the PIM component. The PIM commands instruct the PIM component to perform computational operations that satisfy the memory requests. In the context of dividing an application workload between compute intensive tasks and data intensive tasks, the PIM commands specify instructions for executing the data intensive tasks being offloaded to the computational units of the PIM architecture.

Design constraints of the memory interface, which is managed by the memory controller, effect performance of the PIM architecture. PIM commands have a finite command space to contain instruction information, including static information and dynamic information used to execute the PIM commands. Impacts on PIM command space therefore reduce available command space for dynamic portions of memory addresses, as well as static operator codes, static register indices, static portions of the memory addresses that complement the dynamic portions, etc. A memory interface that has a narrow width or low pin count constrains the PIM command space and limits the amount of information that a PIM command contains. One way to compensate for narrow memory interfaces includes breaking apart individual PIM commands into multiple, partial commands that are transmitted over several processing cycles, which reduces performance. Instead of transmitting partial PIM commands, command buffers provide a way to increase capacity of the PIM command space including to enable coherent transmission of PIM commands, without reducing performance.

Command buffers are implemented near the computational units of PIM-enabled memory banks. The command buffers of a PIM architecture are configured to store static information including but not limited to the examples of static instruction information given above. When command buffers are used, a portion of PIM command space is reserved to communicate a command buffer index indicating where static information of the PIM command is stored. The command buffer index reduces PIM command space reserved for static information that is efficiently retrievable from accessing the command buffers at that command buffer index. Storing static information in a command buffer increases capacity of the PIM command space to transmit greater amounts of dynamic information, e.g., larger portion of a dynamic memory addresses than if command buffers are not used.

The command buffer index indicates a command buffer location where the static information used to execute a corresponding PIM command is stored. A size of the command buffer index is constrained by the size of the memory interface and the finite PIM command space. A larger command buffer index enables larger command buffers, which improves performance, at the cost of increased complexity, additional hardware, increase footprint, and the like. A PIM architecture compensates for smaller command buffers by invoking complex command buffer programming routines, which in some implementations also adds complexity and hinders performance.

Another challenge with offloading data instructions to a PIM architecture is handling issues caused by control flow divergence. Control flow divergence occurs when data instructions offloaded to the PIM architecture cause different memory actions including different results or outcomes depending on the data accessed to implement the data instruction of a PIM command. Conditional instructions are examples of PIM commands that lead to instances of control flow divergence. As used throughout this disclosure, a conditional instruction refers to a PIM command that defines a sequence of one or more memory operations based on the data stored in registers of the PIM architecture and/or the memory, which when executed, cause a result to be based on a plurality of different intermediary results obtained during execution. A response to the PIM request causes an outcome that is computed one way or another depending on one or more conditions defined by the conditional instruction. For example, a result of a conditional store (c-store) is a type of conditional instruction that produces a result (e.g., causes a write to the memory) dependent on an intermediary condition being satisfied (e.g., a comparison between a coefficient and a value computed from data stored in one or more registers in the PIM architecture). Multi-bank instructions are other examples of PIM commands that lead to instances of control flow divergence. A multi-bank instruction, as used throughout this disclosure, refers to a PIM command that causes parallel data instructions to be executed across multiple memory banks, and which result in different outcomes based on differences in the data located in separate blocks (e.g., logical blocks or physical blocks) of memory. For example, a control path follows one direction or another depending on different sets of data stored at same addresses of two different memory banks. Conditional instructions and multi-bank instructions are just two examples of data instructions transmitted through PIM commands that cause control flow divergence. Various other types of data instructions cause different outcome depending on intermediary computations based on stored data, and therefore introduce multiple possible execution paths.

PIM acceleration suffers in the presence of control flow divergence and introduces complexity to the command buffers. For example, in the context of conditional instructions, the command buffer captures each possible execution path by maintaining multiple variants of the same conditional instruction, which reduces capacity of the command buffer to maintain other PIM instructions. Each instance of the same conditional instruction is individually retrieved from the command buffer to evaluate each possible execution path, which degrades performance. Additional resources are consumed whether the conditional instructions are executed serially (e.g., one after the other for conditional instructions accessing a single memory bank) or in parallel (e.g., simultaneously for data instructions that cause data accesses across multiple memory banks).

To improve PIM utilization and performance, the techniques disclosed herein describe instruction deltas to manage control flow divergence. As used herein, the term “instruction deltas” refers to undefined portions of data instructions (e.g., contained in PIM commands) that remain undefined (e.g., in a command buffer) until the data instruction is executed. When instruction deltas are used, a command source (e.g., the memory controller) intentionally sends a data instruction that is incomplete because of one or more undefined portions where at least part of the data instruction is undefined. In one or more aspects, complexity of implementing instruction deltas is reduced by allowing a single instruction delta to be decoded into a single defined portion of a PIM instruction. In one or more variations, where added complexity is acceptable, more than one instruction delta allowed and decodable into multiple defined portions of a PIM instruction. Configuring a PIM architecture to utilize instruction deltas, and intentionally keep parts of data instructions undefined until run-time, has several benefits. For example, using instruction deltas reduces programming complexity of the PIM component (e.g., of the command buffer). In addition, use of instruction deltas improves processing efficiency of the computational unit used to manage divergent control flow situations caused during data instruction executions. In one or more aspects, the instruction deltas enable efficient transmission of PIM requests and PIM commands that elicit corresponding PIM responses, without increasing a bandwidth of the memory interface.

As one example implementation, a system is configured to process PIM commands received from a memory controller. The system includes a memory operable to store data and a PIM component including one or more in-memory processors configured to process the PIM commands based on the data. Each PIM command is directed to the PIM component for executing instructions that perform operations using the data stored in registers of the PIM component and/or in the memory. To improve efficiency of the PIM component processing, the PIM component stores the instructions upon receipt within a command buffer that queues each PIM instruction for processing. A computational unit of the PIM component, for instance, retrieves each PIM instruction from the command buffer (e.g., one at a time) to perform one or more operations and/or computations using the data.

In this example, the system receives at least one PIM command that includes a conditional instruction, such as a conditional store instruction. As indicated above, conditional instructions are a type of data instruction included in PIM commands that frequently encounter divergent control flow paths during execution. To improve processing efficiency and manage divergent control flows, the PIM command received by the system utilizes instruction deltas.

In one or more aspects, the conditional instruction contained in the PIM command received by the system and stored in the command buffer includes instruction deltas. The PIM command, including the undefined portions contained therein, is temporarily stored in the command buffer until the computational unit is ready to execute the conditional instruction, at which time the instruction deltas are decoded. This is in contrast to conventional PIM command processing techniques that store conditional instructions as multiple entries in the command buffer (e.g., one entry for each possible control flow). The instruction deltas enable PIM architectures to reduce size and/or programming complexity of command buffers, which reduces costs and improves power and processing efficiency.

In at least one implementation, the system processes the conditional instruction by operating the computational unit, which identifies the instruction deltas in response to detecting parts of an instruction that are incomplete or undefined. Non-limiting examples of undefined portions of instructions where instruction deltas are used include at least part of an opcode field, a register identifier field, a memory address field, an operand field, a coefficient field, and a command buffer index field. For example, a delta decode unit of the computational unit identifies an instruction delta based on a parameter field (e.g., a location indicating where to store a result of the conditional instruction) having an undefined or invalid register identifier (e.g., the register identifier does not correspond to a register of the PIM component that is usable to store the result).

The computational unit decodes the instruction delta into one or more defined portions of the instruction to be used in place of the undefined portions during execution of the instruction. One or more non-limiting examples of the defined portions used in place of the undefined portions occupied by the delta instructions include one or more of an opcode, a register identifier, at least part of a memory address of the memory, an operand, a coefficient, and a command buffer index. The delta decode unit of the example system, for instance, replaces the invalid or undefined register identifier with information that configures a register coalescer unit of the computational unit to manage or coalesce access to different register values in a register file to evaluate the multiple possible outcomes of the conditional instruction. In at least one aspect, the register coalescer unit coalesces access to different register values used by an arithmetic logic unit (ALU) that is executing operations defined by the conditional instruction. The delta decode unit, in one or more aspects, configures logic of the register coalescer unit to enable ALU operations by automatically managing access to the register file, and enabling the ALU to benefit from processing efficiencies of the register file when computing information for evaluating the multiple possible outcomes by performing different computations based on register values of the computational unit and/or the data stored in the memory.

With reference to the drawings, the following description details example techniques for provisioning instruction deltas in PIM commands to indicate instruction information, e.g., register index, opcode, etc., that remains undefined until runtime. In addition, example techniques for processing PIM commands to resolve and utilize instruction deltas at runtime are detailed with reference to the drawings.

In some aspects, the techniques described herein relate to a system including a memory, and a processing-in-memory component configured to identify an instruction delta based on one or more undefined portions of an instruction of a PIM command, and decode the instruction delta into one or more defined portions of the instruction to be used in place of the undefined portions to execute the instruction.

In some aspects, the techniques described herein relate to a system, wherein the instruction of the PIM command has multiple possible outcomes depending on data stored in registers of the PIM component or in the memory.

In some aspects, the techniques described herein relate to a system, wherein the instruction includes a conditional instruction with at least one dependency based on data stored in registers of the PIM component or in the memory, or a multi-bank instruction with at least one dependency based on the data stored in registers of the PIM component or in a plurality of banks of the memory.

In some aspects, the techniques described herein relate to a system, wherein the undefined portions of the instruction include one or more of an opcode field, a register identifier field, at least part of a memory address field, an operand field, a coefficient field, and a command buffer index field.

In some aspects, the techniques described herein relate to a system, wherein the defined portions include one or more of an opcode, a register identifier, at least part of a memory address of the memory, an operand, a coefficient, and a command buffer index.

In some aspects, the techniques described herein relate to a system, wherein the instruction is a conditional instruction that depends on different values computed based on data stored in registers of the PIM component or in the memory.

In some aspects, the techniques described herein relate to a system, wherein the undefined portions of the conditional instruction include at least one register identifier field for storing one or more of a reference value used during the execution and a result of the execution.

In some aspects, the techniques described herein relate to a system, wherein the instruction is a multi-bank instruction that depends on different values computed based on data stored in different banks of the memory, and the undefined portions of the instruction include at least part of a memory address field identifier field that stores a memory bank identifier used to identify the different banks of the memory.

In some aspects, the techniques described herein relate to a system, wherein the processing-in-memory component includes one or more in-memory processors configured to execute the instruction based on the defined portions.

In some aspects, the techniques described herein relate to a system, wherein the undefined portions of the instruction include at least one a register identifier field, the defined portions of the instruction include a plurality of register values corresponding to the register identifier field, and the processing-in-memory component is further configured to coalesce the plurality of the register values during execution of the instruction.

In some aspects, the techniques described herein relate to a processing-in-memory component including at least one computational unit of at least one in-memory processor that: identifies an instruction delta based on one or more undefined portions of an instruction of a PIM command, decodes the instruction delta into one or more defined portions of the instruction to be used during execution in place of the undefined portions, and executes the instruction based on the defined portions.

In some aspects, the techniques described herein relate to a processing-in-memory component, further including: a command buffer unit that maintains a PIM command including the instruction.

In some aspects, the techniques described herein relate to a processing-in-memory component, further including: a memory interface that receives a PIM command including the instruction from a memory controller.

In some aspects, the techniques described herein relate to a processing-in-memory component, wherein the computational unit includes: a delta decode unit that decodes the instruction delta into the defined portions, a register file unit that maintains register values corresponding to register identifiers from a register index, a register coalescer unit that coalesces a plurality of the register values accessed from the register file during execution of the instruction, and an arithmetic logic unit that executes the instruction based on the defined portions and the plurality of coalesced register values.

In some aspects, the techniques described herein relate to a processing-in-memory component, wherein prior to execution of the instruction by the arithmetic logic unit, the delta decode unit configures the register coalescer unit to coalesce the plurality of the register values based on the defined portions during execution of the instruction.

In some aspects, the techniques described herein relate to a processing-in-memory component, wherein prior to execution of the instruction by the arithmetic logic unit the delta decode unit configures the arithmetic logic unit to execute the instruction based on the decoded defined portions and the plurality of coalesced register values.

In some aspects, the techniques described herein relate to a processing-in-memory component, wherein the PIM command includes a chain of instructions each having a respective instruction delta, and each respective instruction delta is decoded sequentially in an order that the chain of instructions is received.

In some aspects, the techniques described herein relate to a processing-in-memory component, wherein the delta decode unit is configured to decode the instruction delta into a single defined portion of the instruction to be used during the execution, or the delta decode unit is configured to decode the instruction delta into multiple defined portions of the instruction to be used during the execution.

In some aspects, the techniques described herein relate to a method including: identifying, by a processing device, an instruction delta based on one or more undefined portions of an instruction, and decoding, by the processing device, the instruction delta into one or more defined portions of the instruction to be used during execution of the instruction in place of the undefined portions.

In some aspects, the techniques described herein relate to a method, wherein the processing device includes an in-memory processor, the method further including: executing, by the in-memory processor, the instruction based on the defined portions.

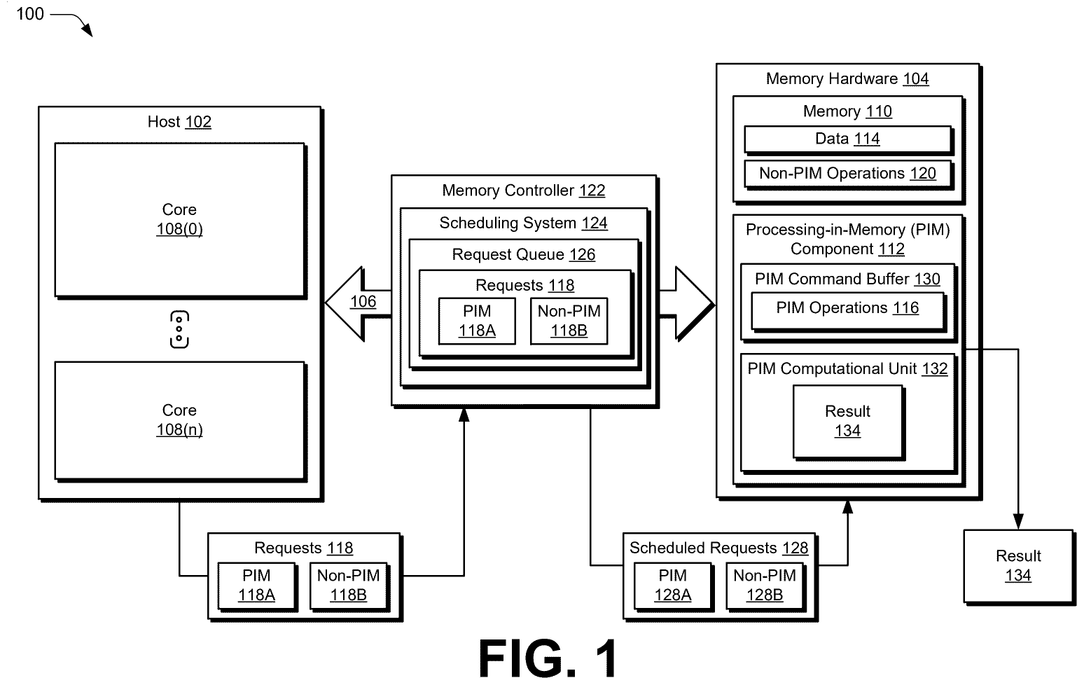

FIG. 1 is a block diagram of a non-limiting example system 100 having a host with at least one core, memory hardware that includes a memory and a processing-in-memory component that uses instruction deltas to manage divergence. The illustrated system 100 includes a host 102 and a memory hardware 104, where the host 102 and the memory hardware 104 are communicatively coupled via a connection/interface 106. In one or more implementations, the host 102 includes at least one core 108. In some implementations, the host 102 includes multiple cores 108. For instance, in the illustrated example, the host 102 is depicted as including core 108(0) and core 108(n), where n represents any integer. The memory hardware 104 includes memory 110 and a PIM component 112.

In accordance with the described techniques, the host 102 and the memory hardware 104 are coupled to one another via a wired or wireless connection, which is depicted in the illustrated example of FIG. 1 as the connection/interface 106. Example wired connections include, but are not limited to, buses, e.g., a data bus, interconnects, traces, and planes. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host 102 is an electronic circuit that includes one or more cores 108 that perform various operations on and/or using data 114 stored in the memory 110. Examples of the host 102 include, but are not limited to, a central processing unit (CPU), a graphics processing unit (GPU), an inference processing unit (IPU), a field programmable gate array (FPGA), an accelerated processing unit (APU), and a digital signal processor (DSP). For example, in one or more implementations, a core 108 is a processing unit that reads and executes instructions, e.g., of a program, examples of which include to add the data 114, to move the data 114, and to branch the data 114.

In one or more implementations, the memory hardware 104 is a circuit board, e.g., a printed circuit board, on which the memory 110 is mounted and includes the processing-in-memory component 112. In some variations, one or more integrated circuits of the memory 110 are mounted on the circuit board of the memory hardware 104, and the memory hardware 104 includes one or more PIM components 112. Examples of the memory hardware 104 include, but are not limited to, a single in-line memory module (SIMM), a dual in-line memory module (DIMM), small outline DIMM (SODIMM), microDIMM, load-reduced DIMM, registered DIMM (R-DIMM), non-volatile DIMM (NVDIMM), high bandwidth memory (HBM), and the like. In one or more implementations, the memory hardware 104 is a single integrated circuit device that incorporates the memory 110 and the PIM component 112 on a single chip. In some examples, the memory hardware 104 is composed of multiple chips that implement the memory 110 and the PIM component 112 as vertical (“3D”) stacks, placed side-by-side on an interposer or substrate, or assembled via a combination of vertical stacking and side-by-side placement.

The memory 110 is a device or system that is used to store information, such as the data 114, for immediate use in a device (e.g., by a core 108 of the host 102 and/or by the PIM component 112). In one or more implementations, the memory 110 corresponds to semiconductor memory where the data 114 is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), such as single data rate (SDR) SDRAM or double data rate (DDR) SDRAM, ferroelectric RAM (FeRAM), resistive RAM (RRAM), a spin-transfer torque magnetic RAM (STT-MRAM), and static random-access memory (SRAM).

Broadly, the PIM component 112 represents one or more in-memory processors (or other logic unit(s)) integrated with a memory system on the same chip. The PIM component 112 (e.g., the one or more in-memory processors) is configured to process PIM memory operations 116, such as operations performed as part of servicing one or more requests 118 received from the core 108 via the connection/interface 106. The PIM component 112 is representative of a processor with example processing capabilities ranging from relatively simple, e.g., an adding machine or an arithmetic logic unit (ALU), to relatively complex (e.g., a CPU/GPU compute core). In an example, the PIM component 112 utilizes one or more in-memory processors to process the requests 118 by executing associated PIM operations 116 using the data 114 stored in the memory 110.

A request 118 encompasses a process of requesting data (e.g., the data 114) from or sending data to the memory hardware 104. The requests 118 are made by a processor or device (e.g., a core 108 of the host 102) to the memory hardware 104 to perform one or more memory operations, such as one or more PIM operations 116 associated with one or more PIM requests 118A and/or one or more non-PIM operations 120, i.e., conventional memory operations, associated with one or more non-PIM requests 118B.

The requests 118 include information such as a memory address that specifies a location of at least a portion of the data 114 to be accessed within the memory 110, a memory operation type (e.g., read or write operation), and control command(s). For the PIM requests 118A, specifically, the information also includes computation instructions that define the computation to be performed by the PIM component 112 on the data 114 within the memory 110. For example, the PIM requests 118A are also referenced throughout as PIM commands, and include information defining PIM based operation codes, such as add, and, subtract, or, xor, compare, etc. The techniques described herein improve on various aspects of PIM technologies. As such, the techniques described herein are useable on the PIM requests 118A. In some implementations, the system 100 is configured to process the PIM requests 118A. In other implementations, the system 100 is configured to process both the PIM requests 118A and the non-PIM requests 118B.

The PIM operations 116 and the non-PIM operations 120 are specific actions performed on the memory hardware 104. The PIM operations 116 are specific actions performed by the PIM component 112, such as actions executed by in-memory processors to implement the computation instructions defined in a PIM request 118A. The non-PIM operations 120 are actions performed on the memory 110, such as reading the data 114 or writing the data 114. The PIM operations 116 significantly improve performance of the system 100 by reducing data movement, minimizing latency, and taking advantage of the parallelism and proximity of data processing within the memory hardware 104. The PIM operations 116 are particularly beneficial for applications workloads with high memory bandwidth requirements, such as data-intensive tasks. Some non-limiting examples of application workloads include genomic workloads, graph analytic workloads, search workloads, gaming workloads, simulation workloads, virtual/augmented reality workloads, and various classes of machine learning workloads. Non-limiting example classes of machine learning workloads include convolution neural network (CNN) models, bidirectional encoder representation from transformer (BERT) models, deep learning recommendation models (DLRM), and so forth.

A memory command is a specific control signal or instruction sent to the memory hardware 104 to perform a particular memory operation, such as one of the non-PIM operations 120 or one of the PIM operations 116. A memory command is a low-level command that directly interacts with a memory controller 122 or the memory 110 to initiate a memory operation. In one or more implementations the connection/interface 106 represents a memory interface communicative coupling the memory controller 122 to the memory hardware 104, and operable to receives a PIM command (e.g., a PIM request 118A or a scheduled PIM request 128A) including an instruction also referred to as a PIM operation 116 from the memory controller 122.

Memory commands are often specific to the memory technology being used, such as DDR memory, where commands like READ, WRITE, PRECHARGE, and ACTIVATE are used to control access to the DDR memory. Specific to the PIM component 112 are PIM commands, such as all-bank PIM commands that are issued to each memory bank within the memory 110 simultaneously to initiate a parallel processing operation. An all-bank PIM command is a low-level control signal sent to each individual memory bank within the memory hardware 104 to coordinate the execution of a computational task in the PIM component 112. A per-bank PIM command is a low-level control signal sent to a single memory bank within the memory hardware 104 to coordinate the execution of a computational task in the PIM component 112.

PIM architectures contrast with conventional computer architectures that obtain data from memory, communicate the data to a remote processing unit, e.g., a core 108 of the host 102, and process the data using the remote processing unit (e.g., using a core 108 of the host 102 rather than the PIM component 112). In various scenarios, the data produced by the remote processing unit as a result of processing the obtained data is written back to memory, which involves communicating the produced data over the connection/interface 106 from the remote processing unit to memory. In terms of data communication pathways, the remote processing unit (e.g., a core 108 of the host 102) is further away from the memory 110 than the PIM component 112, both physically and topologically. As a result, conventional computer architectures suffer from increased data transfer latency, reduced data communication bandwidth, and increased data communication energy, particularly when the volume of data transferred between the memory and the remote processing unit is large, which tends to decrease overall computer performance.

Thus, the PIM component 112 enables increased computer performance while reducing data transfer energy as compared to conventional computer architectures that implement remote processing hardware. Further, the PIM component 112 alleviates some memory performance and energy bottlenecks by moving one or more memory-intensive computations closer to the memory 110. Although the PIM component 112 is illustrated as being disposed within the memory hardware 104, in some examples, the described benefits of using processing-in-memory techniques are realizable through near-memory processing implementations in which the PIM component 112 is disposed in closer proximity to the memory 110, e.g., in terms of data communication pathways, than a core 108 of the host 102.

As mentioned above, the system 100 is further depicted as including the memory controller 122. The memory controller 122 is configured to receive the requests 118 from the host 102 (e.g., from a core 108 of the host 102). Although depicted in the example system 100 as being implemented separately from the host 102, in some implementations, the memory controller 122 is implemented locally as part of the host 102. The memory controller 122 is further configured to schedule the requests 118 for a plurality of hosts 102, despite being depicted in the illustrated example of FIG. 1 as serving a single host 102. For instance, in an example implementation, the memory controller 122 schedules the requests 118 for a plurality of different hosts 102, where each of the plurality of different hosts 102 include one or more cores 108 that submit the requests 118 to the memory controller 122 for scheduling with the memory hardware 104. The memory controller 122 outputs scheduled requests 128 based on the requests 118.

In accordance with one or more implementations, the memory controller 122 is associated with a single channel of the memory 110. For instance, the system 100 is configured to include a plurality of different memory controllers 122, one for each of a plurality of channels of the memory 110. The techniques described herein are thus performable using a plurality of different memory controllers 122 to schedule the requests 118 for different channels of the memory 110. In some implementations, a single channel in the memory 110 is allocated into multiple pseudo-channels. In such implementations, the memory controller 122 is configured to schedule the requests 118 for different pseudo-channels of a single channel in the memory 110.

As depicted in the illustrated example of FIG. 1, the memory controller 122 includes a scheduling system 124. The scheduling system 124 is representative of a digital circuit configured to schedule the requests 118 for execution in a manner that optimizes performance of the system 100 (e.g., limits computational resource consumption, decreases latency, and reduces power consumption of the system 100) when measured over execution of the requests 118. The scheduling system 124 includes a request queue 126. The request queue 126 is configured to maintain a queue of the requests 118 received at the memory controller 122 from the host 102. The illustrated request queue 126 includes both PIM requests 118 and non-PIM requests 118B. In some implementations, the scheduling system 124 includes multiple request queues, such as a PIM request queue for handling PIM requests 118A and a non-PIM request queue for handling non-PIM requests 118B. Alternatively, the memory controller 122 is logically or physically divided into separate memory controllers designed to serve specific types of requests 118, such as a logical or physical memory controller for serving PIM requests 118A and another logical or physical memory controller for serving non-PIM requests 118B. Other variations on this concept are contemplated.

The scheduling system 124 is configured to schedule an order of the requests 118 maintained in the request queue 126 for execution by the PIM component 112 based on PIM requests 118A and/or the memory 110 based on the non-PIM requests 118B). As depicted in the illustrated example of FIG. 1, the requests 118 selected by the scheduling system 124 from the request queue 126 are represented as scheduled requests 128. Specifically, the requests 118 selected by the scheduling system 124 from the request queue 126 for execution by the PIM component 112 are represented as PIM scheduled requests 128A, and the requests 118 selected by the scheduling system 124 for execution by the host 102 are represented as one or more scheduled non-PIM requests 128B. As used throughout this disclosure, the term “PIM request” is used synonymously with “PIM command” to refer to one of the PIM scheduled requests 128. In some implementations, the scheduling system 124 selects a single request 118 from the request queue 126 for inclusion in the scheduled requests 128 per clock cycle of the system 100. Alternatively, the scheduling system 124 selects multiple requests 118 from the request queue 126 for inclusion in the scheduled requests 128 per clock cycle.

The scheduled PIM requests 128A (or PIM commands) are transmitted by the memory controller 122 to a PIM command buffer 130 of the PIM component 112. The PIM command buffer 130 is representative of a data storage structure in the PIM component 112 that maintains a list or queue of PIM commands. For example, the PIM command buffer 130 is a command buffer unit integrated in the PIM component 112 and configured to maintain instructions determined from receiving a PIM command. The PIM requests 128A and the corresponding PIM operations 116 scheduled for execution by the PIM component 112, for instance, are stored in the PIM command buffer 130 until a later time when the PIM operations 116 are executed using or manipulating, at least in part, the data 114 stored in the memory 110.

The PIM component 112 depicted in the illustrated example of FIG. 1 further includes at least one PIM computational unit 132. The PIM computational unit 132 includes hardware logic and circuitry to execute instructions contained in a PIM command (e.g., a scheduled PIM request 128A), non-limiting examples of which are illustrated in the additional drawings. As part of executing a scheduled PIM request 128A, the PIM computational unit 132 executes instructions to perform the PIM operations 116. The PIM computational unit 132 generates a result 134 from executing the instructions identified in a scheduled PIM request 128A. In one or more examples, the result 134 includes results data generated from processing the data 114 stored in the memory 110 during execution of the instructions performed to execute the PIM operations 116.

The instructions included in a scheduled PIM request 128A include configurable instructions for outputting the result 134 in a variety of ways. For instance, in some implementations, executing a scheduled PIM request 128A using the PIM computational unit 132 causes the PIM component 112 to communicate the result 134 to a requesting source, such as the host 102. Alternatively, or additionally, in some implementations, instructions included in the scheduled PIM request 128A cause the PIM component 112 to output the result 134 to a storage location in the memory 110 (e.g., to update the data 114 stored in the memory 110 for subsequent access and/or retrieval by the host 102, and so forth). Alternatively, or additionally, in some implementations, instructions included in the scheduled PIM request 128A and executed at least in part using the PIM computational unit 132 cause the PIM component 112 to store the result 134 locally (e.g., in a register of the PIM component 112).

Because the PIM component 112 executes the scheduled PIM requests 128A on behalf of the host 102, the PIM component 112 is configured to execute the scheduled PIM requests 128A with minimal impact on the system 100 (e.g., without invalidating caches of the system 100 or causing traffic on the connection/interface 106). For instance, the PIM component 112 executes the scheduled PIM requests 128A on the memory 110 “in the background” with respect to the host 102 and the core 108, which frees up cycles of the host 102 and/or the core 108, reduces memory bus traffic (e.g., reduces traffic on the connection/interface 106), and reduces power consumption relative to performing operations at the host 102 and/or the core 108. Notably, because the PIM component 112 is closer to the memory 110 than the core 108 of the host 102 in terms of data communication pathways, evaluating the data 114 stored in the memory 110 is generally completable in a shorter amount of time using the PIM component 112 than if the evaluation were performed using the core 108 of the host 102.

In accordance with one or more implementations, the PIM computational unit 132 is configured to process the PIM operations 116 included in the PIM requests 128A that contain instruction deltas, which leave portions of instructions undefined. The PIM computational unit 132, for instance, retrieves one of the PIM operations 116 from the PIM command buffer 130. The PIM computational unit 132 identifies an instruction delta based on one or more undefined portions of an instruction associated with one or more of the PIM operations 116. Non-limiting examples of undefined portions of instructions where instruction deltas are used include at least part of an opcode field, a register identifier field, a memory address field, an operand field, a coefficient field, and a command buffer index (e.g., indicating where in the PIM command buffer 130 that static information of the PIM operations 116 are stored).

The PIM computational unit 132 decodes the instruction delta when executing the PIM operations 116. For example, the PIM computational unit 132 decodes the instruction delta into one or more defined portions of the instruction to be new information used in place of the undefined portions when the PIM computational unit 132 executes the instruction. Non-limiting examples of the defined portions include one or more of an opcode, a register identifier, a memory address of the memory, an operand, a coefficient, and a command buffer index. Using the defined portions as new information in place of the undefined portions configures the PIM computational unit 132 to fully execute the PIM operation 116 and respond to the corresponding PIM request 128A with the result 134.

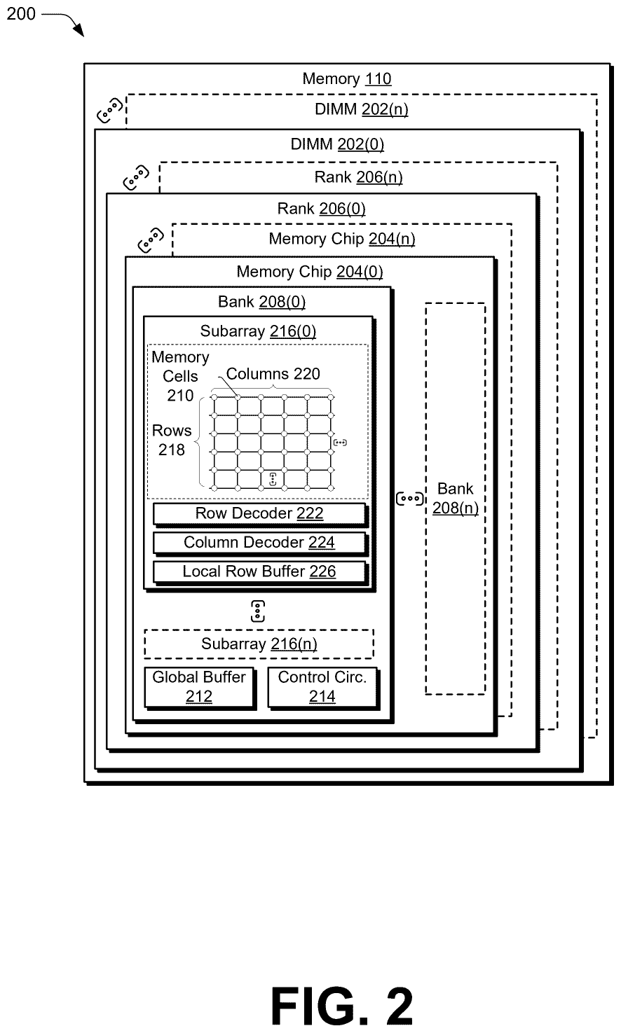

FIG. 2 depicts a non-limiting example memory architecture 200 for the memory 110. The illustrated memory architecture 200 includes one or more DIMMs 202(0)-202(n). Each DIMM 202 is a circuit board that contains one or more memory chips 204(0)-204(n) organized into one or more ranks 206(0)-206(n). A DIMM 202 is a physical module that is inserted into a memory slot on a circuit board, such as motherboard. A DIMM 202 provides a way to expand the memory capacity of a computer system, such as the system 100. A rank 206 is a logical group of memory chips 204 on a DIMM 202. Each rank 206 has a set of memory chips 204 and operates independently of the other ranks 206 on the same DIMM 202. A memory chip 204, also known as a memory module or memory die, is a component that stores data, such as the data 114, in binary form.

Each memory chip 204 includes one or more memory banks (shown as “banks”) 208(0)-208(n). A bank 208 is a subset of memory cells 210 within a memory chip 204. A bank 208 is a small or smallest unit that is accessed independently within a memory chip 204. Each bank 208 has a global buffer 212 and control circuitry 214. The global buffer 212 is shared among multiple memory cells 210 or multiple subarrays 216(0)-216(n). The global buffer 212 provides a temporary storage location for data (e.g., the data 114) being read from or written to the memory cells 210. The global buffer 212 facilitates efficient data transfer and helps manage data flow within a memory bank 208.

Each subarray 216 is a smaller partition within a bank 208. A subarray 216 includes a set of rows 218 and columns 220 of the memory cells 210. Each subarray 216 has a row decoder 222, a column decoder 224, sense amplifiers (not shown), and a local row buffer 226. The division of a bank 208 into subarrays 216 allows for parallelism in accessing and retrieving data (e.g., the data 114) from the memory 110.

The primary function of a row decoder 222 is to decode a memory address provided by the memory controller 122 and activate the appropriate row 218 of memory cells 210 in response. The memory address typically includes a row address and a column address. The row decoder 222 focuses on decoding the row address. The row decoder 222 receives the row address bits from the memory controller 122 as input. The number of row address bits depends on the memory organization and the size of the memory array. The row decoder 222 determines which row 218 of memory cells 210 to activate based on these address bits. Once the row address bits are received, the row decoder 222 performs various logical operations, such as decoding and demultiplexing, to identify the specific row to be activated. This involves activating a set of select lines that correspond to the desired row. The select lines generated by the row decoder 222 are then fed into the word line driver circuitry (e.g., part of the control circuitry 214 of the bank 208 or dedicated circuitry within the subarray 216), which activates the word line associated with the selected row. The word line connects to the gates of the memory cells 210 in the activated row, enabling read or write operations. When the word line associated with the selected row is activated, the word line enables the memory cells 210 within that row to be accessed. The data stored in the cells 210 is read or written depending on the command issued by the memory controller 122. It is be noted that the row decoder 222 operates in conjunction with other memory control circuitry, such as the column decoder 224 and sense amplifiers, to complete memory read or write operations effectively.

The main function of a column decoder 224 is to decode the memory address provided by the memory controller 122 and activate the appropriate column of memory cells 210 in response. The memory address typically consists of a row address and a column address, with the column decoder 224 focusing on decoding the column address. The column decoder 224 receives the column address bits from the memory controller 122 as input. The number of column address bits depends on the memory organization and the size of the memory array. The column decoder 224 determines which column 220 of memory cells 210 to activate based on these address bits. Once the column address bits are received, the column decoder 224 performs various logical operations, such as decoding and demultiplexing, to identify the specific column to be activated. This involves activating a set of select lines that correspond to the desired column 220. The select lines generated by the column decoder 224 are then used to enable the appropriate sense amplifiers in the memory array. Sense amplifiers are used to read and amplify the weak signals from memory cells 210 during read operations or prepare data for write operations. Once the sense amplifiers are activated, the selected column 220 of memory cells 210 are accessed for read or write operations. During a read operation, the data in the selected column 220 is retrieved from the memory cells 210 and forwarded to the memory controller 122 for further processing. In a write operation, the column decoder 224 enables the data from the memory controller 122 to be written into the selected column 220 of memory cells 210. The column decoder 224 works in conjunction with other memory control circuits, such as the row decoder 222 and sense amplifiers, to complete memory read or write operations effectively.

The local row buffer 226, also known as a row buffer or page buffer, is a small, fast access memory storage element located within a memory subarray 216 (as shown) or a bank 208. The local row buffer 226 is a temporary storage space used to hold a row of data that has been accessed from the main memory array. The local row buffer 226 enhances the performance of the memory 110 by reducing the latency associated with accessing data from a memory array. By temporarily storing a complete row of data in the local row buffer 226, subsequent read or write operations within that row are performed more quickly (e.g., without accessing the main memory array).

When a row 218 of memory cells 210 is selected for access using the row decoder 222, the corresponding row's data (e.g., a portion of the data 114) is fetched and loaded into the local row buffer 226. The data 114 is transferred from the memory cells 210 to the local row buffer 226 through bit lines and sense amplifiers. The local row buffer 226 consists of a set of storage elements that hold multiple bits of data 114, typically organized as a multi-bit-wide bus. Each storage element corresponds to a memory cell 210 in the selected row 218. The local row buffer 226 temporarily stores the complete row 218 of data 114, ensuring fast access to any data 114 within that row 218. Once the data 114 is stored in the local row buffer 226, subsequent read or write operations within the same row 218 are performed quickly. Instead of accessing the subarray 216, the data 114 is directly accessed from or written to the local row buffer 226. This significantly reduces the access latency since the data 114 is readily available in a high-speed storage element.

After the completion of the operations within the local row buffer 226, the row 218 is deactivated, and the local row buffer 226 is pre-charged. Pre-charging involves resetting the bit lines and sense amplifiers, preparing these elements for the next row activation. The local row buffer 226 is then ready to hold a different row of data when the next row is accessed. By utilizing a local row buffer 226, the memory 110 exploits the principle of locality and reduces the time used for accessing data within a row. The local row buffer 226 minimizes the number of accesses to the slower subarrays 216 and provides faster access to frequently accessed data, improving overall memory performance.

To further illustrate aspects illustrated in FIG. 2, consider an example where the PIM component 112 from the system 100 is configured to process the PIM operations 116 included in the PIM requests 128A by accessing the memory architecture 200. The PIM operations 116 in this example contain instruction deltas that leave portions of a multi-bank instruction undefined. For example, the PIM operations 116 define a memory address that is to be reused to evaluate data stored at two or more of the banks 208. An undefined portion of the PIM operations 116 represents part of a memory address that designates the memory address as corresponding to a particular one of the banks 208. Without specifying which of the banks 208 are to be accessed for executing the PIM operations 116, the PIM component 112 decodes the undefined portion into a memory address associated with the bank 208(0) and a memory address within the bank 208(n). The PIM component 112 causes parallel execution of the PIM operations 116 to occur by accessing each instance of addressable data stored at the two different banks 208(0) and 208(n). The PIM component 112 evaluates different outcomes of the PIM operations 116 by performing similar computations on the data located in the different banks 208. A resulting control path of the system 100 is operable to follow one direction or another depending on different sets of data stored at two or more different memory banks 208.

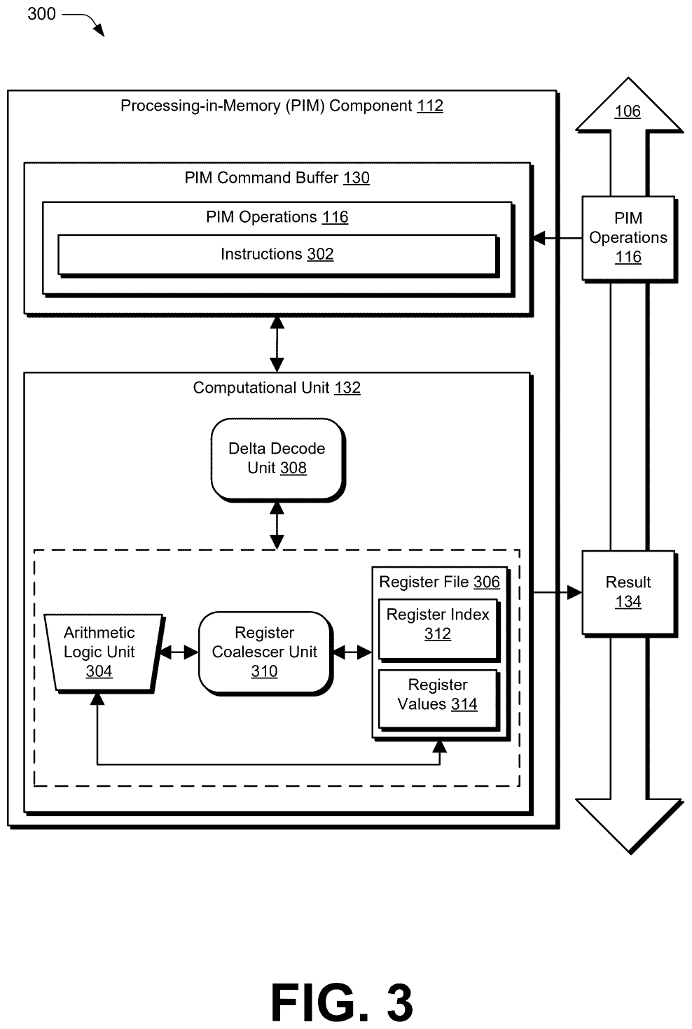

FIG. 3 depicts a non-limiting example 300 of the PIM component 112 for the memory 110, which is operable to process instruction deltas to manage divergence. The PIM component 112 is operable with a memory module (e.g., single DRAM bank, multiple DRAM banks).

The PIM component 112 is communicatively coupled to the connection/interface 106 or other memory interface that receives PIM commands (e.g., the PIM request 128A) including instructions (e.g., the PIM operations 116) from the memory controller 122. The PIM component 112 outputs the result 134 generated in response to executing the PIM operations 116 determined from the PIM request 128A.

The PIM component 112 includes the PIM command buffer 130 used to store the PIM operations 116, and also includes the computational unit 132 used to process the PIM operations 116. The PIM operations 116, for instance, include one or more instructions 302, including conditional instructions and/or multi-bank instructions in one or more aspects. The PIM component 112 is configured to support instruction deltas to address execution divergence in executing the instructions 302. With support to allow instruction deltas and complete them at runtime, instruction commonality across multiple control paths is achievable improving efficiency and performance.

The computational unit 132 includes a near-memory arithmetic logic unit 304 and register file unit 306. The register file unit 306 uses a register index 312 to organize a set of register values 314. The register index 312 is queried based on a register identifier to return a corresponding one of the register values 314. In one or more implementations, the register file unit 306 is a single data structure that implements the register index 312 as a set of identifiers that point to entries in the register file unit 306 where each of the register values 314 is stored. The computational unit 132 further includes a delta decode unit 308 and a register coalescer unit 310 for deducing instruction deltas and managing access to the register file unit 306 at run-time to account for the instruction deltas.

In one or more aspects, the delta decode unit 308 of the computational unit 132 decodes instruction deltas into the defined portions used by the arithmetic logic unit 304 to execute the instructions 302 (e.g., at run-time) of the PIM operations 116 for outputting the result 134. For example, prior to execution of the instruction 302, the delta decode unit 308 configures the register coalescer unit 310 to coalesce a plurality of the register values 314 accessed from the register file unit 306 based on the defined portions. Prior to execution of the instruction 302, in one or more variations, the delta decode unit 308 further configures the arithmetic logic unit 304 to execute the instruction 302 based on the defined portions and the plurality of coalesced register values 314.

In the example 300, incoming PIM operations 116 are retrieved from the PIM command buffer 130 and processed by the delta decode unit 308 to identify the presence of instruction deltas. The delta decode unit 308 configures the arithmetic logic unit 304 and the register coalescer unit 310 to ensure appropriate access to the register file unit 306, which enables the arithmetic logic unit 304 to determine the register value 314. At run-time, the register coalescer unit 310 receives inputs from the arithmetic logic unit 304 to request access to the register file unit 306. Based on a configuration applied to the register coalescer unit 310 by the delta decode unit 308, one or more register values 314 are determined by the register coalescer unit 310 via coalescing accesses to a plurality of the register values 314. The register coalescer unit 310 controls how the register values 314 are provided to the arithmetic logic unit 304 to compute information in furtherance of responding to the scheduled PIM request 128A and/or the PIM request 118A.

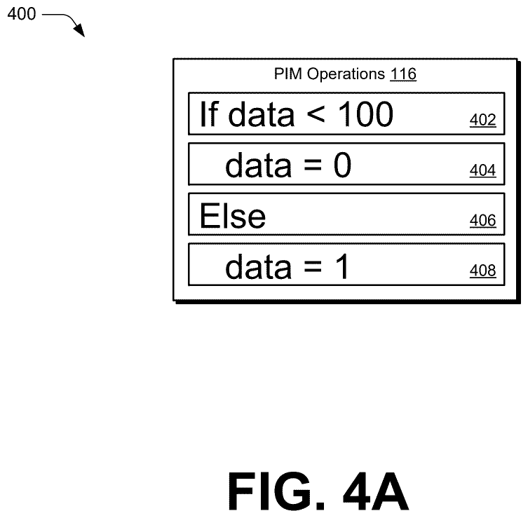

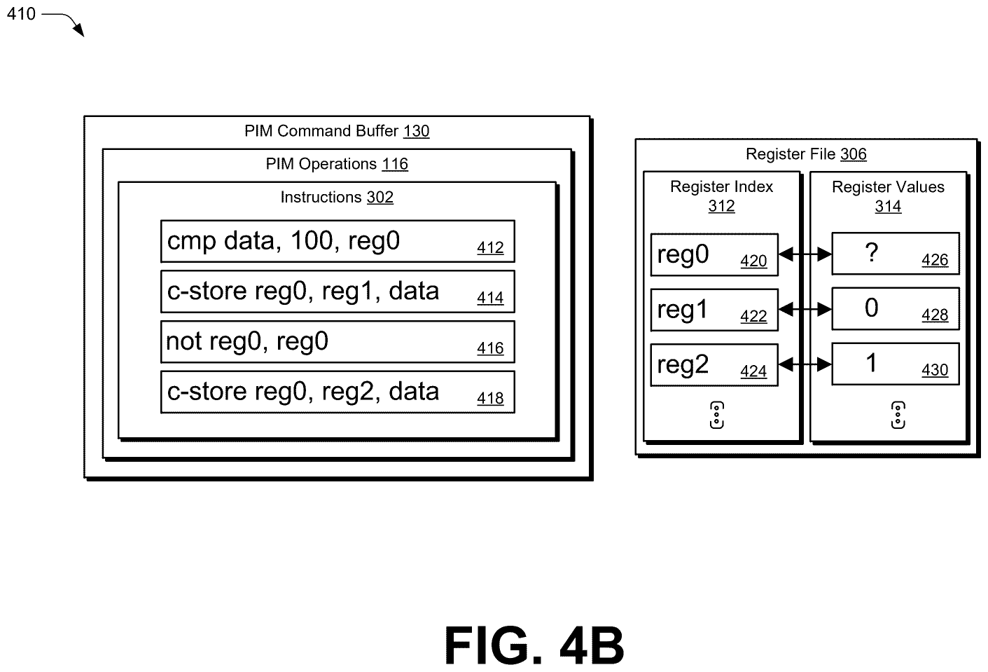

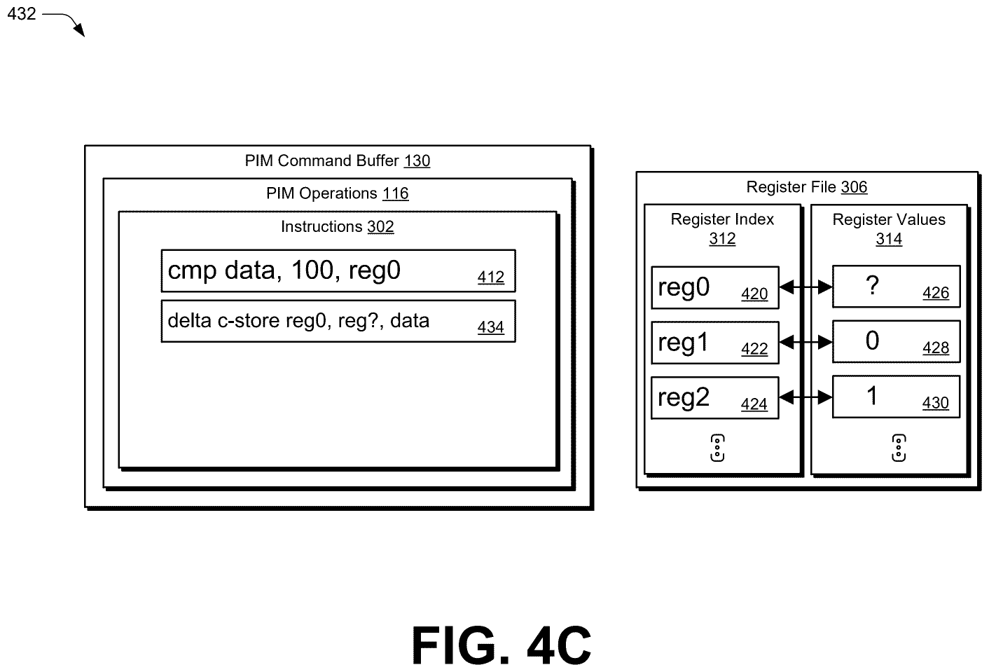

FIG. 4-1 depicts a code snippet 400 as a non-limiting example of a PIM command defining the PIM operations 116, including one or more instructions 302, executed through processing-in-memory. The code snippet 400 represents a program including logical operations performed by the computational unit 132 when executing the instruction 302, which includes conditional operations associated with control flow divergence.

The code snippet 400 represents a set of conditional operations that cause the computational unit 132 to compare whether data stored in the memory 110 is less than a coefficient (e.g., the value one hundred) and store either a zero value as the data when the comparison result is satisfied or a one value when the comparison is not satisfied. As depicted in FIG. 4-1, a first conditional operation 402 is evaluated and if logically true, then data stored in a memory location is set to zero in a second operation 404. A second conditional operation 406 is evaluated as the opposite state of the first conditional operation 402. If the second conditional operation 406 is logically true, then the first conditional operation 402 is logically false, and the data stored in the memory location is set to one in a fourth operation 408.

FIG. 4-2 is an example implementation 410 of the PIM command buffer 130 without supporting instruction deltas to execute the PIM operations 116 defined by the code snippet 400 depicted in FIG. 4-1. As depicted in FIG. 4-2, the instructions 302 are maintained in the PIM command buffer 130 as logical operations performed by the computational unit 132 to execute the code snippet 400 at run-time. In the implementation 410, the PIM component 112 causes the PIM command buffer 130 to store each variant of a conditional control path defined by the code snippet 400. The instructions 302 are retrieved from the PIM command buffer 130 and executed by the computational unit 132.

As depicted in FIG. 4-2, the PIM command buffer 130 includes a first conditional operation 412 that is evaluated by the computational unit 132. The conditional operation 412 includes a comparison operand, a reference to the data in the memory 110, a coefficient to compare to the data in the memory 110, and a register identifier 420 (e.g., reg0) in the register index 312. The register identifier 420 points to a register value 426 among the register values 314, where the result of the comparison executed by the conditional operation 412 is maintained in the register file unit 306. Execution of the conditional operation 412 causes a binary or logical result (e.g., one or zero, true or false) of the comparison between the data and the coefficient to be stored as the register value 426 associated with the register identifier 420, e.g., reg0. For example, performing the conditional operation 412 causes the computational unit 132 to compare whether the data stored in the memory 110 is less than the coefficient of one hundred, and the register value 426 is updated to reflect a binary result of the comparison.

In evaluating a first conditional control flow path of the code snippet 400, the PIM command buffer 130 includes a second conditional operation 414 that is evaluated by the computational unit 132. The conditional operation 414 includes a conditional-store (c-store) operand which causes a value to be stored at a memory location if a condition is satisfied. The conditional operation 414 further includes the register identifier 420 associated with the register value 426 used as the source of the condition, a register identifier 422 (e.g., reg1) used as a register value 428 to be written to the memory 110 if the conditional-store operand is satisfied, and a location within the memory 110 where the data is set to the register value 428 if the conditional-store operand is satisfied.

The PIM command buffer 130 includes a third conditional operation 416 that includes a not operand, the register identifier 420 associated with the register value 426 on which the operand is performed, and the register identifier 420 associated with the register value 426 at which a result of the operand is stored. The computational unit 132 executes the third conditional operation 416 to invert the register value 426 stored in the register identifier 420 (e.g., reg0).

In evaluating a second conditional control flow path of the code snippet 400, the PIM command buffer 130 includes a fourth conditional operation 418 that is evaluated by the computational unit 132. The conditional operation 418 includes a second c-store operand, the register identifier 420 associated with the register value 426 used as the source of the condition, a register identifier 424 (e.g., reg2) used as a register value 430 to be written to the memory 110 if the conditional-store operand is satisfied, and a location within the memory 110 where the data is set to the register value 430 if the conditional-store operand is satisfied.

In summary, without using instruction deltas, the PIM command buffer 130 causes the computational unit 132 to execute four operations (e.g., the conditional operation 412, the conditional operation 414, the conditional operation 416, and the conditional operation 418. At least two operations are performed to evaluate both conditional control flow paths of the code snippet 400. Based on the instruction 302, the computational unit 132 compares whether the data stored in the memory 110 is less than the coefficient one hundred and writes the result in the reg0 as a binary result of the comparison. Then the computational unit 132 performs a conditional store to write the value of reg1 as the data stored in the memory 110 if the binary result of the comparison is positive (e.g., the data represents a value less than the coefficient one hundred). After inverting the comparison result stored in the reg0, then the computational unit 132 performs another conditional store to write the value of reg2 as the data stored in the memory 110 if the inverted binary result of the comparison is positive (e.g., the data represents a value not less than the coefficient one hundred).

FIG. 4-3 is a non-limiting example implementation 432 of the PIM command buffer 130 for supporting instruction deltas to execute the PIM operations 116 defined by the code snippet 400 depicted in FIG. 4-1. In one or more implementations, by supporting instruction deltas deduced at run-time, a single instruction 302 in the PIM command buffer 130 index is configurable to express multiple instructions 302. This increases capacity of the PIM command buffer. With instruction deltas, the instructions 302 of the PIM operations 116 occupy fewer storage locations (e.g., fewer rows) including without increasing a command buffer index transmitted over the connection/interface 106. Instruction commonality is harnessed across multiple control paths allowing multiple control paths to be evaluated efficiently (e.g., at least partially in parallel) to further improve performance. Performance of the PIM component 112 improves by reducing command cycles, and reducing programming complexity (e.g., the instruction deltas reduce invocations of large and/or complex command buffer programming routines).

For example, similar to the implementation 410, the implementation 432 depicted in FIG. 4-3 includes the PIM command buffer 130 as having the conditional operation 412, which at runtime is evaluated by the computational unit 132. Execution of the conditional operation 412 causes a binary or logical result (e.g., one or zero, true or false) of the comparison between the data and the coefficient to be stored as the register value 426 associated with the register identifier 420, e.g., reg0.

In contrast to the implementation 410 that stores the conditional operation 414, the conditional operation 416, and the conditional operation 418, the PIM command buffer 130 depicted in the implementation 432 maintains a single delta conditional operation, which is labeled as a delta conditional operation 434. The delta conditional operation 434 is a delta c-store operation including an undefined portion. The undefined portion in the implementation 410 is an undefined register identifier field for the register index 312 in the register file unit 306. The undefined register identifier field is associated with a source register (e.g., reg1 or reg2) for conditions evaluated in executing the delta c-store operation. The undefined portion remains undefined until runtime when the computational unit 132 evaluates the delta conditional operation 434.

To configure the computational unit 132 to execute the delta conditional operation 434, the delta decode unit 308 includes programming and/or logic enabling the delta decode unit 308 to derive the undefined portion. For example, the delta decode unit 308 determines that the undefined portion has two possible register identifiers to enable both control flow paths to be evaluated. One possible register identifier is the register identifier 422 (e.g., reg1) associated with the register value 428 and the other possible register identifier is the register identifier 424 (e.g., reg2) associated with the register value 430. Part of the tasks performed by the delta decode unit 308 is to determine based on the delta conditional operation 434 each possible value or defined portion (e.g., register identifier in this case) that replaces the undefined portion.

In response to determining defined portions of the delta conditional operation that replace the undefined portion, the delta decode unit 308 sends signals to the register coalescer unit 310 to enable the delta conditional operation 434 to be evaluated at in connection with the arithmetic logic unit 304 and the register file unit 306, at runtime. By using instruction deltas, the PIM command buffer 130 causes the computational unit 132 to either store the register value 428 as the data in the memory 110 if the register value 426 derived from executing the conditional operation 412 is one or true (e.g., the conditional operation 412 is satisfied) or store the register value 430 to the memory 110 if the register value 426 is zero or false (e.g., the conditional operation 412 is not satisfied).

As an example, for the code snippet 400 depicted in FIG. 4-1, the instruction stream executed by the computational unit 132 in the implementation 432 includes half the instructions 302 as the quantity of the instructions 302 executed by the computational unit 132 in the implementation 410. The implementation 432 leads to improved performance and less complexity in design, complexity, and/or programming used to implement the PIM command buffer 130.

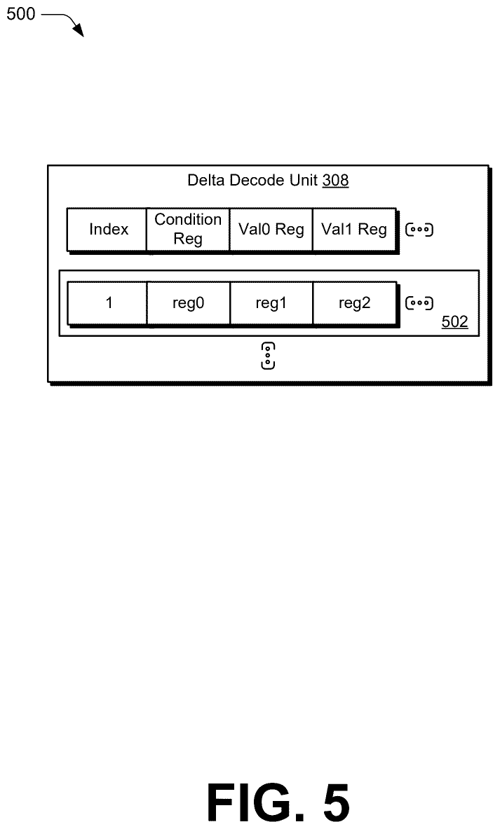

FIG. 5 depicts a non-limiting example implementation 500 of the delta decode unit 308 for decoding instruction deltas used to execute the PIM operations 116 extracted from PIM commands (e.g., the PIM request 128A). As mentioned above, the delta decode unit 308 identifies instruction deltas contained in the PIM operations 116 that have undefined portions and then decodes the undefined portions into defined portions to be used in place of the instruction deltas when executing the PIM operations 116.

The delta decode unit 308 decodes the instruction deltas using an associated command buffer index 502 (e.g., a row in a table with index value 1 in FIG. 5). The command buffer index 502 causes the delta decode unit 308 to use a conditional register identifier (e.g., the reg0) as mask/condition register that combines register values associated with possible source value registers (e.g., the reg1 and the reg2). In response to decoding the two possible register values, the delta decode unit 308 configures the register coalescer unit 310 to appropriately control access to the register file unit 306 when the instruction 302 is executed by the arithmetic logic unit 304.

In one or more aspects, the delta decode unit 308 represents an existing decoder used in PIM that is modified to handle instruction deltas. For example, existing decoders are augmentable with functionality usable to decode instruction deltas. One or more existing decoders already infer a register to be accessed for a given instruction. Modifying such decoder to perform the functions of the delta decode unit 308 to detect instruction deltas and manage register access using the register coalescer unit 310 enables the omission of the delta decode unit 308 as a separate component of the computational unit 132.

In at least one variation, the delta decode unit 308 is operable to decode multiple instruction deltas to execute the PIM operation 116. For example, multiple instruction deltas (e.g., undefined portions of the PIM operation 116) are received by the delta decode unit 308 via chaining. The PIM operation 116 includes a chain of instructions, each having a respective instruction delta. Each respective instruction delta in the chain of instructions is decoded sequentially in an order that the chain of instructions is received. The delta decode unit 308 decodes a first instruction delta to perform an initial part of the PIM operation 116 (e.g., an initial instruction) received in the chain. The decoding of the first instruction delta then allows decoding of a second instruction delta to perform a subsequent part of the PIM operation 116 (e.g., a subsequent instruction) received in the chain. This process is repeated to enable multiple instruction deltas to be sequentially decoded from processing a chain of instructions that make up the PIM operations 116. In one or more implementations, a “none operation” (commonly referred to as a “no op” or “NOP”) is executed by the computational unit 132 (e.g., in between each instruction delta decoding) to allow the delta decode unit 308 and/or the register coalescer unit 310 time to finish decoding an earlier instruction delta received in the chain.

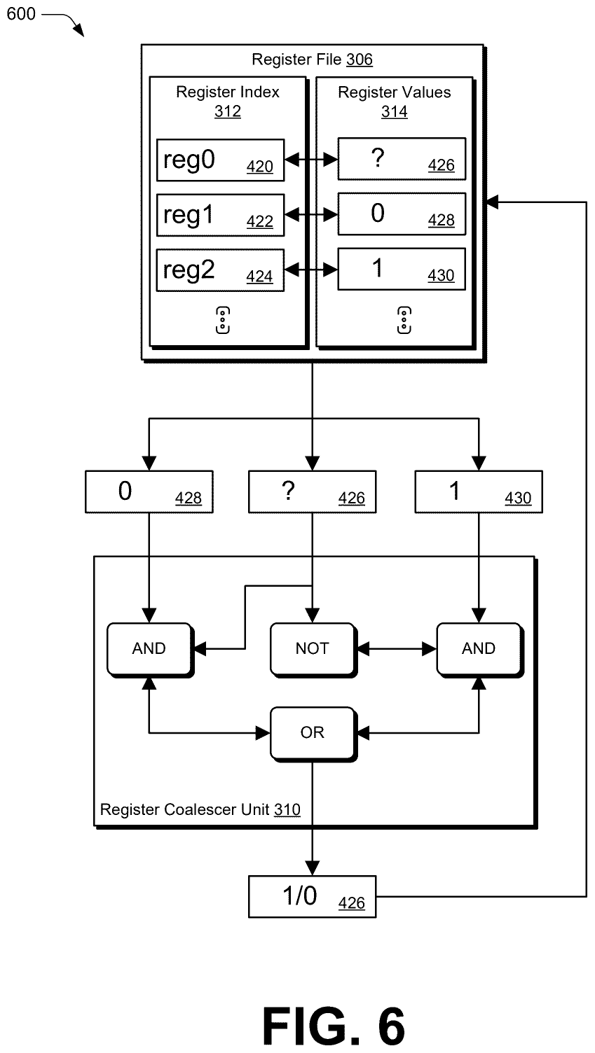

FIG. 6 depicts a non-limiting example implementation 600 of the register coalescer unit 310 for managing access of the register file unit 306 used to execute the PIM operations 116 extracted from PIM commands that utilize instruction deltas. The register coalescer unit 310 processes instruction deltas pertaining to register indexes based on commands, signals, or programming controlled by the delta decode unit 308.

In the implementation 600 depicted in FIG. 6, the delta decode unit 308 configures the register coalescer unit 310 to perform one or more logical operations (e.g., and, or, masking) to the register values 314 used to perform the delta conditional operation 434 defined in the instructions 302 of the PIM operations 116. The register coalescer unit 310 reads one or more of the register values 314, applies mask operations, and combines resultant values to derive the register value 426 that is eventually stored as the data written to the memory 110.

For example, the arithmetic logic unit 304 performs operations to execute the conditional store by relying on the register coalescer unit 310 to automatically fill in details associated with the register index 312 left undefined by the instruction delta. In response to being configured by the delta decode unit 308, the register coalescer unit 310 performs an and operation between the register value 428 and 426 and another and operation between the register value 430 and a not (inverted) version of the register value 426. By performing a logical or operation on the results of these two and operations, the register coalescer unit 310 enables the arithmetic logic unit 304 to evaluate the multiple control paths and compute the appropriate result of the delta conditional operation 434, which is stored by the register coalescer unit 310 in the register file unit 306 as the register value 426.

Note that, while the condition register (e.g., reg0) is depicted in the various examples as a general-purpose register used for decoding instruction deltas, in alternate implementations a separate mask register (not shown) is used. In at least one example where the condition register is a general-purpose register, the delta decode unit 308 also includes (e.g., writes) a specific value to the conditional register (e.g., reg0) to enable the register coalescer unit 310 to appropriately perform masking operations with the other register values (e.g., reg1 and reg2). In one or more examples, register offsets and other functions are executed by the delta decode unit 308 to deduce the correct register index for the register coalescer unit 310.

As described throughout, different forms of instruction deltas are possible, such as undefined portions of opcode fields. Instruction deltas for opcodes introduce further complexity in the delta decode unit 308. To tame complexity, when a single instruction delta per instruction is allowed, opcode deltas are allowed for instructions with same register(s) and/or other same instruction information. Adherence to security protocols limits instructions deltas being used for opcodes in one or more examples.

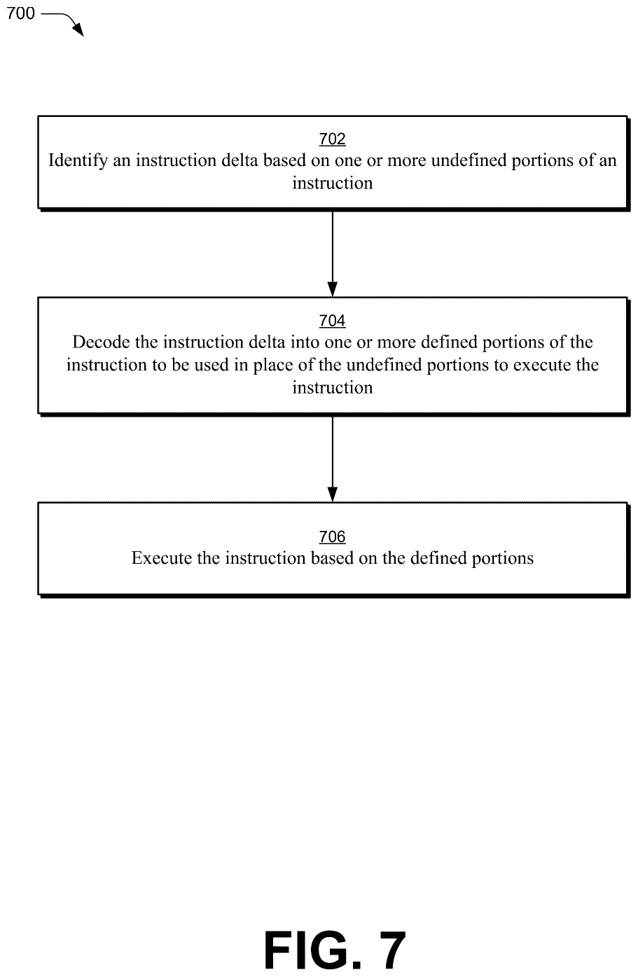

FIG. 7 depicts a method 700 performed by a system operable to process PIM commands utilizing instruction deltas. The method 700 begins and proceeds to block 702. At block 702, the PIM component 112 identifies an instruction delta based on one or more undefined portions of an instruction. For example, an in-memory processor of the PIM component 112 determines the instruction delta based on the instruction. From block 702, the method 700 proceeds to block 704. At block 704, the PIM component 112 decodes the instruction delta into one or more defined portions of the instruction to be used in place of the undefined portions to execute the instruction. The in-memory processor of the PIM component 112, for instance, decodes the instruction delta to define portions of the instruction that are undefined. From block 704, the method 700 ends at block 706 where the PIM component 112 executes the instruction based on the defined portion. The in-memory processors of the PIM component 112 process the instruction using the defined portion(s) determined to be used in place of the undefined portions of the instruction.

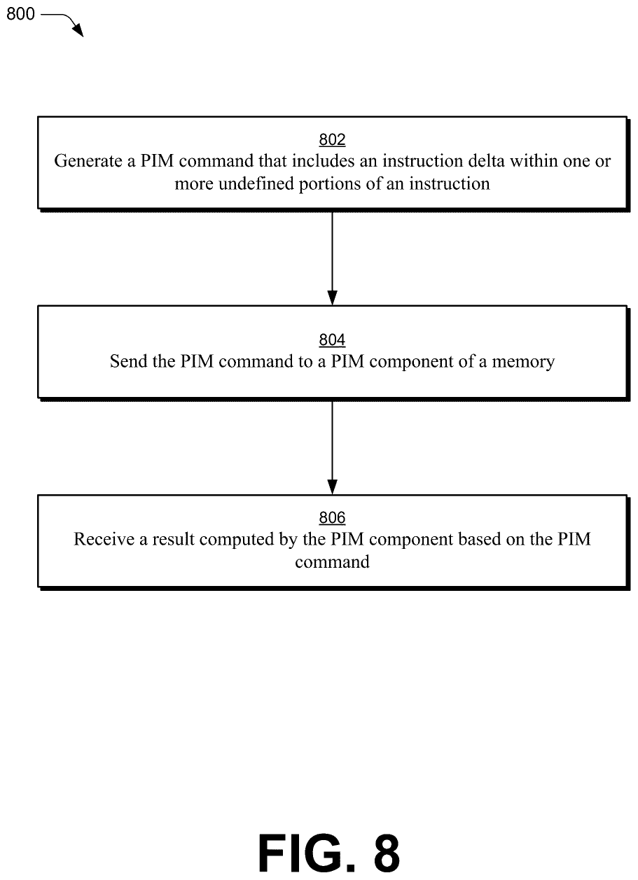

FIG. 8 depicts a method 800 performed by a processing unit to cause a system to process PIM commands utilizing instruction deltas. The method 800 begins and proceeds to block 802. At block 802, the host 102 or the memory controller 122 generates a PIM command that includes an instruction delta within one or more undefined portions of an instruction. The method 800 proceeds to block 804 where the PIM command is sent (e.g., via the connection/interface 106) to the PIM component 112 of the memory hardware 104. The method 800 finishes at block 806 where the host 102 or the memory controller 122 that generated the PIM command receives a result 134 computed by the PIM component 112 based on the PIM command. For example, the result 134 is output from the in-memory processors of the PIM component 112 to satisfy the PIM request.

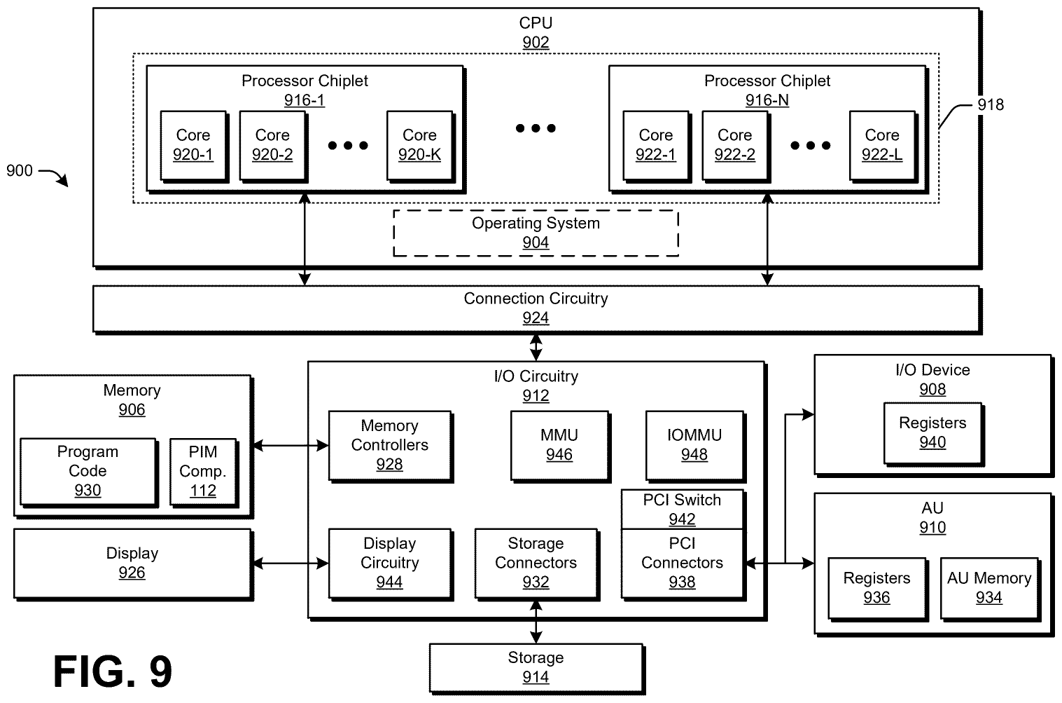

FIG. 9 includes a processing system 900 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IOT) device, an automotive computer or computer for another type of vehicle, a networking device, a medical device or system, and other computing devices or systems.

In the illustrated example, the processing system 900 includes a central processing unit (CPU) 902. In one or more implementations, the CPU 902 is configured to run an operating system (OS) 904 that manages the execution of applications. For example, the OS 904 is configured to schedule the execution of tasks (e.g., instructions) for applications, allocate portions of resources (e.g., system memory 906, CPU 902, input/output (I/O) device 908, accelerator unit (AU) 910, storage 914) for the execution of tasks for the applications, provide an interface to I/O devices (e.g., I/O device 908) for the applications, or any combination thereof.

In this example, the PIM component 112 is depicted in the memory 906. In variations, however, the PIM component 112 or aspects thereof are included in and/or is implemented by one or more different components of the processing system 900, such as the CPU 902, the memory 906, the I/O device 908, the AU 910, the I/O circuitry 912, the storage 914, and so forth. In at least one implementation, the PIM component 112 or portions of the PIM component 112 are included in at least two of the depicted components of the processing system 900. By way of example, aspects of the PIM component 112 may be included in or otherwise implemented by at least the I/O circuitry 612 and the system memory 906.

The CPU 902 includes one or more processor chiplets 916, which are communicatively coupled together by a data fabric 918 in one or more implementations.

Each of the processor chiplets 916, for example, includes one or more processor cores 920, 922 configured to concurrently execute one or more series of instructions, also referred to herein as “threads,” for an application. Further, the data fabric 918 communicatively couples each processor chiplet 916-N of the CPU 902 such that each processor core (e.g., processor cores 920) of a first processor chiplet (e.g., 916-1) is communicatively coupled to each processor core (e.g., processor cores 922) of one or more other processor chiplets 916. Though the example embodiment presented in FIG. 9 shows a first processor chiplet (916-1) having three processor cores (920-1, 920-2, 920-K) representing a K number of processor cores 922 and a second processor chiplet (916-N) having three processor cores (e.g., 922-1, 922-2, 922-L) representing an L number of processor cores 922, in other implementations (L being an integer number greater than or equal to one), each processor chiplet 916 may have any number of processor cores 920, 922. For example, each processor chiplet 916 can have the same number of processor cores 920, 922 as one or more other processor chiplets 916, a different number of processor cores 920, 922 as one or more other processor chiplets 916, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 900, the CPU 902 is communicatively coupled to an I/O circuitry 912 by a connection circuitry 924. For example, each processor chiplet 916 of the CPU 902 is communicatively coupled to the I/O circuitry 912 by the connection circuitry 924. The connection circuitry 924 includes, for example, one or more data fabrics, buses, buffers, queues, and the like. The I/O circuitry 912 is configured to facilitate communications between two or more components of the processing system 900 such as between the CPU 902, system memory 906, display 926, universal serial bus (USB) devices, peripheral component interconnect (PCI) devices (e.g., I/O device 908, AU 910), storage 914, and the like.

As an example, system memory 906 includes any combination of one or more volatile memories and/or one or more non-volatile memories, examples of which include dynamic random-access memory (DRAM), static random-access memory (SRAM), non-volatile RAM, and the like. To manage access to the system memory 906 by CPU 902, the I/O device 908, the AU 910, and/or any other components, the I/O circuitry 912 includes one or more memory controllers 928. These memory controllers 928, for example, include circuitry configured to manage and fulfill memory access requests issued from the CPU 902, the I/O device 908, the AU 910, or any combination thereof. Examples of such requests include read requests, write requests, fetch requests, pre-fetch requests, or any combination thereof. That is to say, these memory controllers 928 are configured to manage access to the data stored at one or more memory addresses within the system memory 906, such as by CPU 902, the I/O device 908, and/or the AU 910.

When an application is to be executed by processing system 900, the OS 904 running on the CPU 902 is configured to load at least a portion of program code 930 (e.g., an executable file) associated with the application from, for example, a storage 914 into system memory 906. This storage 914, for example, includes a non-volatile storage such as a flash memory, solid-state memory, hard disk, optical disc, or the like configured to store program code 930 for one or more applications.

To facilitate communication between the storage 914 and other components of processing system 900, the I/O circuitry 912 includes one or more storage connectors 932 (e.g., universal serial bus (USB) connectors, serial AT attachment (SATA) connectors, PCI Express (PCIe) connectors) configured to communicatively couple storage 914 to the I/O circuitry 912 such that I/O circuitry 912 is capable of routing signals to and from the storage 914 to one or more other components of the processing system 900.

In association with executing an application, in one or more scenarios, the CPU 902 is configured to issue one or more instructions (e.g., threads) to be executed for an application to the AU 910. The AU 910 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 910 includes one or more compute units that concurrently execute one or more threads of an application and store data resulting from the execution of these threads in AU memory 934. This AU memory 934, for example, includes any combination of one or more volatile memories and/or non-volatile memories, examples of which include caches, video RAM (VRAM), or the like. In one or more implementations, these compute units are also configured to execute these threads based on the data stored in one or more physical registers 936 of the AU 910.

To facilitate communication between the AU 910 and one or more other components of processing system 900, the I/O circuitry 912 includes or is otherwise connected to one or more connectors, such as PCI connectors 938 (e.g., PCIe connectors) each including circuitry configured to communicatively couple the AU 910 to the I/O circuitry such that the I/O circuitry 912 is capable of routing signals to and from the AU 910 to one or more other components of the processing system 900. Further, the PCIe connectors 938 are configured to communicatively couple the I/O device 908 to the I/O circuitry 912 such that the I/O circuitry 912 is capable of routing signals to and from the I/O device 908 to one or more other components of the processing system 900.

By way of example and not limitation, the I/O device 908 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 908 is configured to execute one or more operations, tasks, instructions, or any combination thereof based on one or more physical registers 940 of the I/O device 908. In one or more implementations, such physical registers 940 are configured to maintain data (e.g., operands, instructions, values, variables) indicating one or more operations, tasks, or instructions to be performed by the I/O device 908.

To manage communication between components of the processing system 900 (e.g., AU 910, I/O device 908) that are connected to PCI connectors 938, and one or more other components of the processing system 900, the I/O circuitry 912 includes PCI switch 942. The PCI switch 942, for example, includes circuitry configured to route packets to and from the components of the processing system 900 connected to the PCI connectors 938 as well as to the other components of the processing system 900. As an example, based on address data indicated in a packet received from a first component (e.g., CPU 902), the PCI switch 942 routes the packet to a corresponding component (e.g., AU 910) connected to the PCI connectors 938.

Based on the processing system 900 executing a graphics application, for instance, the CPU 902, the AU 910, or both are configured to execute one or more instructions (e.g., draw calls) such that a scene including one or more graphics objects is rendered. After rendering such a scene, the processing system 900 stores the scene in the storage 914, displays the scene on the display 926, or both. The display 926, for example, includes a cathode-ray tube (CRT) display, liquid crystal display (LCD), light emitting diode (LED) display, organic light emitting diode (OLED) display, or any combination thereof. To enable the processing system 900 to display a scene on the display 926, the I/O circuitry 912 includes display circuitry 944. The display circuitry 944, for example, includes high-definition multimedia interface (HDMI) connectors,

DisplayPort connectors, digital visual interface (DVI) connectors, USB connectors, and the like, each including circuitry configured to communicatively couple the display 926 to the I/O circuitry 912. Additionally or alternatively, the display circuitry 944 includes circuitry configured to manage the display of one or more scenes on the display 926 such as display controllers, buffers, memory, or any combination thereof.

Further, the CPU 902, the AU 910, or both are configured to concurrently run one or more virtual machines (VMs), which are each configured to execute one or more corresponding applications. To manage communications between such VMs and the underlying resources of the processing system 900, such as any one or more components of processing system 900, including the CPU 902, the I/O device 908, the AU 910, and the system memory 906, the I/O circuitry 912 includes memory management unit (MMU) 946 and input-output memory management unit (IOMMU) 948. The MMU 946 includes, for example, circuitry configured to manage memory requests, such as from the CPU 902 to the system memory 906. For example, the MMU 946 is configured to handle memory requests issued from the CPU 902 and associated with a VM running on the CPU 902. These memory requests, for example, request access to read, write, fetch, or pre-fetch data residing at one or more virtual addresses (e.g., guest virtual addresses) each indicating one or more portions (e.g., physical memory addresses) of the system memory 906. Based on receiving a memory request from the CPU 902, the MMU 946 is configured to translate the virtual address indicated in the memory request to a physical address in the system memory 906 and to fulfill the request. The IOMMU 948 includes, for example, circuitry configured to manage memory requests (memory-mapped I/O (MMIO) requests) from the CPU 902 to the I/O device 908, the AU 910, or both, and to manage memory requests (direct memory access (DMA) requests) from the I/O device 908 or the AU 910 to the system memory 906. For example, to access the registers 940 of the I/O device 908, the registers 936 of the AU 910, and/or the AU memory 934, the CPU 902 issues one or more MMIO requests. Such MMIO requests each request access to read, write, fetch, or pre-fetch data residing at one or more virtual addresses (e.g., guest virtual addresses) which each represent at least a portion of the registers 940 of the I/O device 908, the registers 936 of the AU 910, or the AU memory 934, respectively. As another example, to access the system memory 906 without using the CPU 902, the I/O device 908, the AU 910, or both are configured to issue one or more DMA requests. Such DMA requests each request access to read, write, fetch, or pre-fetch data residing at one or more virtual addresses (e.g., device virtual addresses) which each represent at least a portion of the system memory 906. Based on receiving an MMIO request or DMA request, the IOMMU 948 is configured to translate the virtual address indicated in the MMIO or DMA request to a physical address and fulfill the request.

In variations, the processing system 900 can include any combination of the components depicted and described. For example, in at least one variation, the processing system 900 does not include one or more of the components depicted and described in relation to FIG. 9. Additionally or alternatively, in at least one variation, the processing system 900 includes additional and/or different components from those depicted. The 900 is configurable in a variety of ways with different combinations of components in accordance with the described techniques.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host 102, the memory hardware 104, the connection/interface 106, the core 108, the memory 110, the PIM component 112, the memory controller 122, the scheduling system 124, the PIM command buffer 130, the PIM computational unit 132, the delta decode unit 304, the arithmetic logic unit 304, the register coalescer unit 308, and the register file unit 306) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A system comprising:
a memory; and
a processor in memory configured to:
identify an instruction delta that includes one or more undefined portions of an instruction of a processing-in-memory (PIM) PIM command; and
decode the instruction delta into one or more defined portions of the instruction to be used in place of the one or more undefined portions to execute the instruction.

2. The system of claim 1, wherein the instruction of the PIM command has multiple possible outcomes depending on data stored in registers of the processor in memory or in the memory.

3. The system of claim 1, wherein the instruction is a conditional instruction with at least one dependency based on data stored in registers of the processor in memory or in the memory, or a multi-bank instruction with at least one dependency based on the data stored in registers of the processor in memory or in a plurality of banks of the memory.

4. The system of claim 1, wherein the one or more undefined portions of the instruction include one or more of an opcode field, a register identifier field, at least part of a memory address field, an operand field, a coefficient field, and a command buffer index field.

5. The system of claim 1, wherein the one or more defined portions include one or more of an opcode, a register identifier, at least part of a memory address of the memory, an operand, a coefficient, and a command buffer index.

6. The system of claim 1, wherein the instruction is a conditional instruction that depends on different values computed based on data stored in registers of the processor in memory or in the memory.

7. The system of claim 6, wherein the one or more undefined portions of the conditional instruction include at least one register identifier field for storing one or more of a reference value used during execution and a result of the execution.

8. The system of claim 1, wherein the instruction is a multi-bank instruction that depends on different values computed based on data stored in different banks of the memory, and the one or more undefined portions of the instruction include at least part of a memory address field that stores a memory bank identifier used to identify the different banks of the memory.

9. The system of claim 1, wherein the processor in memory is configured to execute the instruction based on the one or more defined portions.

10. The system of claim 9, wherein the one or more undefined portions of the instruction include at least one register identifier field, the one or more defined portions of the instruction include a plurality of register values corresponding to the at least one register identifier field, and the processor in memory is further configured to coalesce the plurality of register values during execution of the instruction.

11. A processor in memory, comprising at least one computational unit configured to:
identify an instruction delta that includes one or more undefined portions of an instruction of a processing-in-memory (PIM) command;
decode the instruction delta into one or more defined portions of the instruction to be used during execution in place of the one or more undefined portions; and
execute the instruction based on the one or more defined portions.

12. The processor in memory of claim 11, further comprising:
a command buffer unit that maintains the PIM command including the instruction.

13. The processor in memory of claim 11, further configured to receive the PIM command including the instruction from a memory controller.

14. The processor in memory of claim 11, wherein the at least one computational unit includes:
a delta decode unit that decodes the instruction delta into the one or more defined portions;
a register file unit that maintains register values corresponding to register identifiers from a register index;
a register coalescer unit that coalesces a plurality of the register values accessed from the register file unit during execution of the instruction; and
an arithmetic logic unit that executes the instruction based on the one or more defined portions and the plurality of coalesced register values.

15. The processor in memory of claim 14, wherein prior to execution of the instruction by the arithmetic logic unit, the delta decode unit configures the register coalescer unit to coalesce the plurality of the register values based on the one or more defined portions during execution of the instruction.

16. The processor in memory of claim 14, wherein prior to execution of the instruction by the arithmetic logic unit, the delta decode unit configures the arithmetic logic unit to execute the instruction based on the one or more defined portions and the plurality of coalesced register values.

17. The processor in memory of claim 13, wherein the PIM command includes a chain of instructions, each instruction of the chain of instructions having a respective instruction delta, and each respective instruction delta is decoded sequentially in an order that the chain of instructions is received.

18. The processor in memory of claim 14, wherein the delta decode unit is configured to decode the instruction delta into a single defined portion of the instruction to be used during the execution, or the delta decode unit is configured to decode the instruction delta into multiple defined portions of the instruction to be used during the execution.

19. A method comprising:
identifying, by a processing device, an instruction delta based on including one or more undefined portions of an instruction; and
decoding, by the processing device, the instruction delta into one or more defined portions of the instruction to be used during execution of the instruction in place of the one or more undefined portions.

20. The method of claim 19, wherein the processing device includes an in-memory processor, the method further comprising:
executing, by the in-memory processor, the instruction based on the one or more defined portions.
